(19) United States
(12) Patent Application Publication
(10) Pub. No.: US 2026/0327453 A1
(43) Pub. Date: Oct. 22, 2026

(54) AQUEOUS MIXTURES OF NOVEL POLY(HYDROXYALKANOATES)

(71) Applicant: Danimer IPCo, LLC, Bainbridge, GA (US)

(72) Inventors: Michael N. Mang, Bainbridge, GA (US); Phillip Van Trump, Atlanta, GA (US); Michael J. Joyce, Gilbert, AZ (US); Joe B. Grubbs, III, Bishop, GA (US); Karson Durie, Athens, GA (US)

(73) Assignee: Danimer IPCo, LLC, Bainbridge, GA (US)

(21) Appl. No.: 18/998,729

(22) PCT Filed: Jul. 31, 2023
(86) PCT No.: PCT/US23/29092

§ 371 Date: Jan. 27, 2025

Related U.S. Application Data
(60) Provisional application No. 63/393,474, filed on Jul. 29, 2022.

(51) Int. Cl. C09D 167/04; C08G 63/06; C09D 7/45; C09D 7/61; C09D 7/63; C09D 7/65; D21H 19/62; D21J 1/08

(52) U.S. Cl. CPC C09D 167/04; C08G 63/06; C09D 7/45; C09D 7/61; C09D 7/63; C09D 7/65; D21H 19/62; D21J 1/08

(57) ABSTRACT

A biodegradable aqueous mixture for coating substrates is disclosed. The mixture includes from about 35 to about 75 weight percent water and from about 25 to about 65 weight percent solids. The solids include from about 40 to about 99 weight percent of a first poly(hydroxyalkanoate) based on the total dry weight of the solids, wherein the first poly(hydroxyalkanoate) is made up of at least 1 mole percent monomer repeat units of 3-hydroxypropionate.

### FIELD

This disclosure relates to biodegradable polymeric compositions. More particularly, this disclosure relates to biodegradable coatings for paperboard substrates and the like, made from aqueous mixtures of poly(hydroxyalkanoates) (“PHAs”).

### BACKGROUND

Disposable articles, such as food service items, may readily be advantageously fabricated from substrates such as paperboard, which decompose relatively quickly after landfill disposal. However, a simple, uncoated paperboard substrate often performs poorly because the paperboard will rapidly soak up water and/or grease, compromising the paperboard's strength. Consequently, paperboard-based articles are typically coated with a thin polymer layer to improve water and grease resistance.

Coating made from polymers such as polyethylene (PE), polypropylene (PP), or poly(ethylene terephthalate) (PET) may significantly improve the resistance of the paperboard to water and/or grease absorption; however, such polymers do not readily degrade or decompose after landfill disposal. Thus, the paperboard items coated with such polymers may subsist in landfills for centuries after disposal.

Thus, it would be desirable to provide a new coating for substrates such as food service items that is fully biodegradable. Moreover, it would also be desirable if this biodegradable coating provided good water and grease resistance—i.e., water and grease resistance comparable to that of conventional, nonbiodegradable coatings.

Further still, it would be desirable to provide a biodegradable coating which may be applied to a substrate at a relatively low coating weight while still providing barrier properties such as low oxygen transmission rate and water vapor transmission rate. It would also be desirable to provide a substrate coated with such a material.

### SUMMARY

In response to the foregoing and other needs, the present disclosure provides a biodegradable aqueous mixture for coating substrates. According to one embodiment, this aqueous mixture is made up of from about 35 to about 75 weight percent water and from about 25 to about 65 weight percent solids. The solids, in turn, are made up of from about 40 to about 99 weight percent of a first poly(hydroxyalkanoate) based on the total dry weight of the solids.

This first poly(hydroxyalkanoate) is made up of at least 1 mole percent monomer repeat units of 3-hydroxypropionate. Preferably, the first poly(hydroxyalkanoate) is made up of at least 50 mole percent monomer repeat units of 3-hydroxypropionate and, even more preferably, 75 mole percent monomer repeat units of 3-hydroxypropionate.

In certain embodiments, the first poly(hydroxyalkanoate) in the aqueous mixture is preferably made up of poly(3-hydroxypropionate).

In other embodiments, the first poly(hydroxyalkanoate) in the aqueous mixture is preferably a copolymer or a terpolymer. This copolymer or terpolymer is made up of
a first repeat unit which is (3-hydroxypropionate),
a second repeat unit according to Formula I

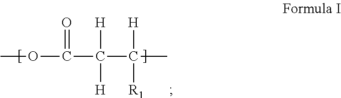

optionally, a third repeat unit according to Formula II,

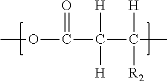

wherein R1 and R2 are each independently selected from the group consisting of linear or branched alkyl groups having from 1 to 22 carbon atoms.

In some embodiments, the first poly(hydroxyalkanoate) is preferably a copolymer, and R₁ is methyl. In some instances, this poly(hydroxyalkanoate) copolymer is preferably made of from about 10 to about 90 mole percent of the first repeat unit and from about 90 to about 10 mole percent of the second repeat unit. More preferably, the poly(hydroxyalkanoate) copolymer is made of from about 30 to about 70 mole percent of the first repeat unit and from about 70 to about 30 mole percent of the second repeat unit.

In other embodiments, the first poly(hydroxyalkanoate) is preferably a terpolymer in which R₁ is methyl and R₂ is propyl. In some instances, this poly(hydroxyalkanoate) terpolymer is preferably made of from about 15 to about 75 mole percent of the first repeat unit, from about 75 to about 15 mole percent of the second repeat unit, and from about 1 to about 5 mole percent of the third repeat unit. More preferably, the terpolymer is preferably made of from about 30 to about 60 mole percent of the first repeat unit, from about 60 to about 30 mole percent of the second repeat unit, and from about 1 to about 5 mole percent of the third repeat unit.

According to certain embodiments, the first poly(hydroxyalkanoate) preferably has a weight average molecular weight, as determined by ASTM D4001-20, of at least 50,000 Daltons. More preferably, the first poly(hydroxyalkanoate) has a weight average molecular weight, as determined by ASTM D4001-20, from about 50,000 to about 1,000,000 Daltons.

In some embodiments, according to the present disclosure, the solids of the aqueous mixture may include a second poly(hydroxyalkanoate) and the first poly(hydroxyalkanoate). This second poly(hydroxyalkanoate) does not include monomer repeat units of 3-hydroxypropionate.

In other embodiments, the solids of the aqueous mixture may also include at least one biodegradable polymer selected from the group consisting of polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, nano-cellulose, isosorbide esters, and mixtures thereof.

In some embodiments, the mixture preferably also includes from about 0.01 weight percent to about 5.0 weight percent of at least one surfactant selected from the group consisting of polysorbates, aromatic polyethylene oxides, sorbitan derivatives, block copolymers of poly(ethylene oxide) and poly(propylene oxide), poly(glycol ethers), poly(vinyl alcohol), alkyl sulfates, alkyl phosphates, stearates, and mixtures thereof.

According to certain embodiments, the mixture preferably also includes from about 0.01 weight percent to about 5.0 weight percent of at least one rheology modifier selected from the group consisting of polysaccharides, acrylate-based emulsion copolymers, viscosity depressants, and viscosity enhancers.

In some instances, the mixture preferably also includes from about 0.01 weight percent to about 2.5 weight percent of at least one wetting and dispersing agent.

In accordance with certain embodiments, the mixture preferably also includes from about 0.01 weight percent to about 0.5 weight percent of at least one biocide or biostatic agent.

In certain embodiments, the mixture preferably also includes from about 0.1 weight percent to about 5.0 weight percent of at least one coalescing agent selected from the group consisting of bio-succinic acid-based coalescing solvent, 2,2,4-trimethyl-1,3-pentanediol monoisobutyrate, dimethyl carbonate, methanol, ethanol, ketones, acetates, and or mixtures thereof.

In some embodiments, the mixture also preferably from about 0.05 to about 1 weight percent of at least one defoamer selected from the group consisting of polyether siloxanes, polyamide particles, and mixtures thereof.

In some embodiments, the mixture preferably also includes from about 1 weight percent to about 35 weight percent of at least one filler selected from the group consisting of clays, calcium carbonate, talc, kaolinite, montmorillonite, bentonite, silica, chitin, titanium dioxide, nano clay, or mixtures thereof.

In certain embodiments, the mixture includes poly(hydroxyalkanoate) particles having a Dv (90) particle size of no more than about 20 microns and, more preferably, no more than about 10 microns, as determined using ISO 8130-13:201.

According to certain embodiments, the mixture, when applied as a substrate coating, preferably has an oxygen transmission rate of less than 50 cc/m²/24 h, as determined according to ASTM D3985. In some instances, the mixture, when applied as a substrate coating, has an oxygen transmission rate from 10 to 50 cc/m²/24 h, as determined according to ASTM D3985.

In certain embodiments, the mixture, when applied as a substrate coating, has a water vapor transmission rate of less than 50 g/m²/24 h, according to ASTM F1249. In some instances, the mixture, when applied as a substrate coating, has a water vapor transmission rate from 10 to 50 g/m²/24 h, according to ASTM F1249.

In a further aspect, the present disclosure also provides a coated substrate. This coated substrate includes a paperboard substrate having at least a first surface and a second surface; and a coating layer over at least the first surface, wherein the coating is formed by applying the aforementioned biodegradable aqueous mixture.

### DETAILED DESCRIPTION

Again, the present disclosure provides a biodegradable aqueous mixture for coating substrates. In general, the aqueous mixture may take the form of either a suspension, an emulsion, or a colloid.

As used in this context, a “suspension” means a heterogeneous mixture of at least two substances, the dispersed material, and the dispersion medium. The particles of a suspension can be separated using filtration. The particles of the suspension will also have a greater propensity to settle under the influence of gravity as compared to certain other mixtures, such as a colloid.

As used herein, a “colloid” is a heterogeneous mixture whose particle size is intermediate between those of a solution and a suspension. The dispersed particles are spread evenly throughout the dispersion medium, i.e., the liquid water. The particles present in a colloid will exhibit a light scattering effect known as the Tyndall effect.

As used herein, an “emulsion” is a type of colloid wherein an emulsifying agent (such as a surfactant) is present.

In general, the mixture includes water and solids. In general, the mixture comprises from about 35 to about 75 weight percent water and from about 25 to about 65 weight percent solids. In some instances, the mixture more preferably comprises from about 45 to about 55 weight percent water and from about 45 to about 55 weight percent solids.

The solids of the mixture, in turn, comprise at least poly(hydroxyalkanoates) and may also comprise other biopolymers and/or additives. Typically, the solids comprise from about 40 to about 99 weight percent of a first poly(hydroxyalkanoate), based on the total dry weight of the solids. In some embodiments, the solids more preferably comprise from about 40 to about 50 weight percent of a first poly(hydroxyalkanoate), based on the total dry weight of the solids.

Importantly, the aforementioned first poly(hydroxyalkanoate) is made up of at least 1 mole percent monomer repeat units of 3-hydroxypropionate. Preferably, the first poly(hydroxyalkanoate) is made up of at least 50 mole percent monomer repeat units of 3-hydroxypropionate and, even more preferably, 75 mole percent monomer repeat units of 3-hydroxypropionate.

In general, the first poly(hydroxyalkanoate) of the composition may be a homopolymer, a copolymer, or a terpolymer. Thus, in certain embodiments, the first poly(hydroxyalkanoate) is a homopolymer, namely, poly(3-hydroxypropionate).

In other embodiments, the poly(hydroxyalkanoate) is a copolymer or a terpolymer which is made up of
a first repeat unit which is (3-hydroxypropionate),
a second repeat unit according to Formula I

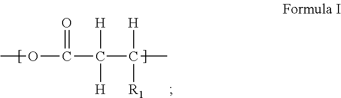

optionally, a third repeat unit according to Formula II,

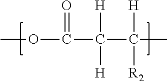

wherein R₁ and R₂ are each independently selected from the group consisting of linear or branched alkyl groups having from 1 to 22 carbon atoms.

In some embodiments, the poly(hydroxyalkanoate) is more preferably a copolymer, and R₁ is methyl. In such embodiments, the poly(hydroxyalkanoate) copolymer is generally made up of from about 10 to about 90 mole percent of the first repeat unit and from about 90 to about 10 mole percent of the second repeat unit. More preferably, the poly(hydroxyalkanoate) copolymer is made of from about 30 to about 70 mole percent of the first repeat unit and from about 70 to about 30 mole percent of the second repeat unit.

In other embodiments, the poly(hydroxyalkanoate) is more preferably a terpolymer, in which R₁ is methyl and R₂ is propyl. In such embodiments, the poly(hydroxyalkanoate) terpolymer is generally made up of from about 15 to about 75 mole percent of the first repeat unit, from about 75 to about 15 mole percent of the second repeat unit, and from about 1 to about 5 mole percent of the third repeat unit. More preferably, the terpolymer is preferably made of from about 30 to about 60 mole percent of the first repeat unit, from about 60 to about 30 mole percent of the second repeat unit, and from about 1 to about 5 mole percent of the third repeat unit.

The first poly(hydroxyalkanoate) typically has a weight average molecular weight of at least 50,000 Daltons when measured in accordance with ASTM D4001-20. More preferably, the first poly(hydroxyalkanoate) has a weight average molecular weight, as determined by ASTM D4001-20, from about 50,000 to about 1,000,000 Daltons.

While the first poly(hydroxyalkanoate) may be prepared by fermentation in a bioreactor, the first poly(hydroxyalkanoate) is, in some embodiments, preferably prepared synthetically via the ring-opening polymerization of a substituted lactone. For instance, the 3-hydroxypropionate repeat units may be formed from the ring-opening polymerization of beta-propiolactone.

When synthesized in this manner, it has been found that the particles of the first poly(hydroxyalkanoate) so formed are typically smaller in size than particles of poly(hydroxyalkanoate) formed via biofermentation. In some embodiments, the mixture includes particles of the first poly(hydroxyalkanoate) having a Dv (90) particle size of no more than about 20 microns and, more preferably, no more than about 10 microns, as determined using ISO 8130-13:201.

In some instances, the solids of the aqueous mixture may include a second poly(hydroxyalkanoate) in addition to the first poly(hydroxyalkanoate). This second poly(hydroxyalkanoate) does not include monomer repeat units of 3-hydroxypropionate. For instance, the second poly(hydroxyalkanoate) may comprise poly(hydroxybutyrate) or poly-3-hydroxybutyrate-co-3-hydroxyhexanoate (“P (3HB-co-3HHx)”). When present, the second poly(hydroxyalkanoate) typically comprises from about 1 to about 50 weight percent of the solids.

Further, the solids of the aqueous mixture may also include at least one biodegradable polymer selected from the group consisting of polybutylene succinate, polybutylene succinate co butylene adipate (“PBSA”), polybutylene adipate co butylene terephthalate (“PBAT”), polycaprolactone, polylactic acid, poly(vinyl alcohol), polyglycolic acid, polyglycolic acid/polylactic acid copolymer, cellulose acetate, nano-cellulose, isosorbide esters, and mixtures thereof. In more preferred embodiments, the solids may comprise PBSA and/or PBAT. When present, the additional biopolymer typically comprises from about 1 to about 50 weight percent of the solids.

As noted above, the mixture may also include various additives in addition to the aforementioned biopolymers.

For instance, the mixture in some embodiments may comprise from about 0.01 weight percent to about 5.0 weight percent of at least one surfactant selected from the group consisting of polysorbates, aromatic polyethylene oxides, sorbitan derivatives, block copolymers of poly(ethylene oxide) and poly(propylene oxide), poly(glycol ethers), poly(vinyl alcohol), alkyl sulfates, alkyl phosphates, stearates, and mixtures thereof.

In certain embodiments, the mixture may also from about 0.01 weight percent to about 5.0 weight percent of at least one rheology modifier selected from the group consisting of polysaccharides, acrylate-based emulsion copolymers, viscosity depressants, and viscosity enhancers.

The mixture may also comprise from about 0.01 weight percent to about 2.5 weight percent of at least one wetting and dispersing agent, i.e., a bifunctional additive that provides both a wetting function and a dispersing function for the solids in the mixture. Examples of suitable wetting and dispersing agents include polysorbates, polyesters, ethoxylates, and amphiphilic chemicals.

In accordance with certain embodiments, the mixture preferably also includes from about 0.01 weight percent to about 0.5 weight percent of at least one biocide or biostatic agent.

Moreover, in certain embodiments, the mixture may also comprise from about 0.1 weight percent to about 5.0 weight percent of at least one coalescing agent selected from the group consisting of bio-succinic acid-based coalescing solvent, 2,2,4-trimethyl-1,3-pentanediol monoisobutyrate, dimethyl carbonate, methanol, ethanol, ketones, acetates, and or mixtures thereof.

In some embodiments, the mixture also preferably from about 0.05 to about 1 weight percent of at least one defoamer selected from the group consisting of polyether siloxanes, polyamide particles, and mixtures thereof.

In some embodiments, the mixture preferably also includes from about 1 weight percent to about 35 weight percent of at least one filler selected from the group consisting of clays, calcium carbonate, talc, kaolinite, montmorillonite, bentonite, silica, chitin, titanium dioxide, nano clay, or mixtures thereof.

The mixture of the present disclosure may be prepared by combining water, the first polyhydroxyalkanoate, any second polyhydroxyalkanoate, and any additives in a mixing vessel. Typically, the components of the mixture are combined using a high-shear mixer, such as a Silverson mixer. Alternatively, the components of the mixture may be combined in a pressurized vessel, such as a Parr reactor.

The present disclosure also provides a coated substrate. The substrate material is typically a paperboard material having a first surface and a second surface. A coating of the aforementioned biodegradable aqueous mixture is applied over at least the first surface of the substrate. In some instances, both the first and the second surfaces of the substrate are coated.

According to certain embodiments, the mixture, when applied as a substrate coating, preferably has an oxygen transmission rate of less than 50 cc/m²/24 h, as determined according to ASTM D3985. In some instances, the mixture, when applied as a substrate coating, has an oxygen transmission rate from 10 to 50 cc/m²/24 h, as determined according to ASTM D3985.

In certain embodiments, the mixture, when applied as a substrate coating, has a water vapor transmission rate of less than 50 g/m²/24 h, according to ASTM F1249. In some instances, the mixture, when applied as a substrate coating, has a water vapor transmission rate from 10 to 50 g/m²/24 h, according to ASTM F1249.

In a further aspect, the present disclosure also provides a coated substrate. This coated substrate includes a paperboard substrate having at least a first surface and a second surface; and a coating layer over at least the first surface, wherein the coating is formed by applying the aforementioned biodegradable aqueous mixture.

The aqueous mixture is typically applied using rod, gravure, or air knife coating application techniques and then dried to provide a solid coating on the substrate.

Once dried and solidified, the coating weight is typically about 5 to about 20 g/m², as determined by ASTM F2217. This is a comparatively low coating weight for a biodegradable coating. Coatings formed from biodegradable polymers are more typically applied at a coating weight from about 20 to about 40 g/m², as determined by ASTM F2117.

Despite these relatively low coating weights, the coatings of the present invention have been found to provide excellent barrier property performance.

As noted above, the mixture, when applied as a substrate coating, preferably has an oxygen transmission rate of less than 50 cc/m²/24 h, as determined according to ASTM D3985. In some instances, the mixture, when applied as a substrate coating, has an oxygen transmission rate from 10 to 50 cc/m²/24 h, as determined according to ASTM D3985.

With regard to moisture vapor transmission, the mixture, when applied as a substrate coating, has a water vapor transmission rate of less than 50 g/m²/24 h, according to ASTM F1249. In some instances, the mixture, when applied as a substrate coating, has a water vapor transmission rate from 10 to 50 cc/m²/24 h, according to ASTM F1249.

The present disclosure is also further illustrated by the following embodiments:

Embodiment 1. A biodegradable aqueous mixture for coating substrates, the mixture comprising:
from about 35 to about 75 weight percent water and from about 25 to about 65 weight percent solids,
wherein the solids comprise from about 40 to about 99 weight percent of a first poly(hydroxyalkanoate) based on the total dry weight of the solids, and
wherein the first poly(hydroxyalkanoate) comprises at least 1 mole percent monomer repeat units of 3-hydroxypropionate.

Embodiment 2. The biodegradable aqueous mixture of Embodiment 1, wherein the first poly(hydroxyalkanoate) comprises at least 50 mole percent monomer repeat units of 3-hydroxypropionate and even more preferably 75 mole percent monomer repeat units of 3-hydroxypropionate.

Embodiment 2. The biodegradable aqueous mixture of Embodiment 1, wherein the first poly(hydroxyalkanoate) comprises poly(3-hydroxypropionate).

Embodiment 3. The biodegradable aqueous mixture of Embodiment 1 or 2, wherein the first poly(hydroxyalkanoate) is a copolymer or a terpolymer which comprises
a first repeat unit which is (3-hydroxypropionate),
a second repeat unit according to Formula I

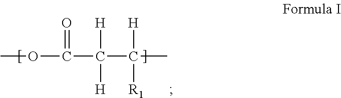

optionally, a third repeat unit according to Formula II,

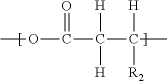

wherein R1 and R2 are each independently selected from the group consisting of linear or branched alkyl groups having from 1 to 22 carbon atoms.

Embodiment 4. The biodegradable aqueous mixture of Embodiment 3, wherein the first poly(hydroxyalkanoate) comprises a copolymer and R₁ is methyl.

Embodiment 5. The biodegradable aqueous mixture of Embodiment 4, wherein the poly(hydroxyalkanoate) copolymer comprises from about 10 to about 90 mole percent of the first repeat unit and from about 90 to about 10 mole percent of the second repeat unit.

Embodiment 6. The biodegradable aqueous mixture of Embodiment 3, wherein the first poly(hydroxyalkanoate) comprises a terpolymer, R₁ is methyl, and R₂ is propyl.

Embodiment 7. The biodegradable aqueous mixture of Embodiment 6, wherein the poly(hydroxyalkanoate) copolymer comprises from about 15 to about 75 mole percent of the first repeat unit, from about 75 to about 15 mole percent of the second repeat unit, and from about 1 to about 5 mole percent of the third repeat unit.

Embodiment 8. The biodegradable aqueous mixture of any of the preceding Embodiments, wherein the first poly(hydroxyalkanoate) has a weight average molecular weight, as determined by ASTM D4001-20, of at least 50,000 Daltons.

Embodiment 9. The biodegradable aqueous mixture of any of the preceding Embodiments, wherein the first poly(hydroxyalkanoate) has a weight average molecular weight, as determined by ASTM D4001-20, from about 50,000 to about 1,000,000 Daltons.

Embodiment 10. The biodegradable aqueous mixture of any of the preceding Embodiments, wherein the solids further comprise a second poly(hydroxyalkanoate) which does not include monomer repeat units of 3-hydroxypropionate.

Embodiment 11. The biodegradable aqueous mixture of any of the preceding Embodiments, wherein the solids further comprise at least one biodegradable polymer selected from the group consisting of polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, nano-cellulose, isosorbide esters, and mixtures thereof.

Embodiment 12. The biodegradable aqueous mixture of any of the preceding Embodiments, wherein the mixture further comprises from about 0.01 weight percent to about 5.0 weight percent of at least one surfactant selected from the group consisting of polysorbates, aromatic polyethylene oxides, sorbitan derivatives, block copolymers of poly(ethylene oxide) and poly(propylene oxide), poly(glycol ethers), poly(vinyl alcohol), alkyl sulfates, alkyl phosphates, stearates, and mixtures thereof.

Embodiment 13. The biodegradable aqueous mixture of any of the preceding Embodiments, wherein the mixture further comprises from about 0.01 weight percent to about 5.0 weight percent of at least one rheology modifier selected from the group consisting of polysaccharides, acrylate-based emulsion copolymers, viscosity depressants, and viscosity enhancers.

Embodiment 14. The biodegradable aqueous mixture of any of the preceding Embodiments, wherein the mixture further comprises from about 0.01 weight percent to about 2.5 weight percent of at least one wetting and dispersing agent.

Embodiment 15. The biodegradable aqueous mixture of any of the preceding Embodiments, wherein the mixture further comprises from about 0.01 weight percent to about 0.5 weight percent of at least one biocide or biostatic agent.

Embodiment 16. The biodegradable aqueous mixture of any of the preceding Embodiments, wherein the mixture further comprises from about 0.1 weight percent to about 5.0 weight percent of at least one coalescing agent selected from the group consisting of bio-succinic acid-based coalescing solvent, 2,2,4-trimethyl-1,3-pentanediol monoisobutyrate, dimethyl carbonate, methanol, ethanol, ketones, acetates, and or mixtures thereof.

Embodiment 16. The biodegradable aqueous mixture of any of the preceding Embodiments, wherein the mixture further comprises from about 0.05 to about 1 weight percent of at least one defoamer selected from the group consisting of polyether siloxanes, polyamide particles, and mixtures thereof.

Embodiment 17. The biodegradable aqueous mixture of any of the preceding Embodiments, wherein the mixture further comprises from about 1 weight percent to about 35 weight percent of at least one filler selected from the group consisting of clays, calcium carbonate, talc, kaolinite, montmorillonite, bentonite, silica, chitin, titanium dioxide, nano clay, or mixtures thereof.

Embodiment 18. The biodegradable aqueous mixture of any of the preceding Embodiments, wherein the mixture comprises poly(hydroxyalkanoate) particles having a Dv (90) particle size of no more than about 20 microns, and more preferably no more than about 10 microns, as determined using ISO 8130-13:201.

Embodiment 19. The biodegradable aqueous mixture of any of the preceding Embodiments, wherein the mixture, when applied as a substrate coating, has an oxygen transmission rate of less than 50 cc/m2/24 h, as determined according to ASTM D3985.

Embodiment 20. The biodegradable aqueous mixture of any of the preceding Embodiments, wherein the mixture, when applied as a substrate coating, has an oxygen transmission rate from 10 to 50 cc/m²/24 h, as determined according to ASTM D3985.

Embodiment 21. The biodegradable aqueous mixture of any of the preceding Embodiments, wherein the mixture, when applied as a substrate coating, has a water vapor transmission rate of less than 50 g/m²/24 h, according to ASTM F1249.

Embodiment 22. The biodegradable aqueous mixture of any of the preceding Embodiments, wherein the mixture, when applied as a substrate coating, has a water vapor transmission rate from 10 to 50 g/m²/24 h, according to ASTM F1249.

Embodiment 23. A coated substrate comprising:
a paperboard substrate having at least a first surface and a second surface; and
a coating layer over at least the first surface, wherein the coating is formed by applying the biodegradable aqueous mixture of any of the preceding Embodiments.

Embodiment 24. The coated substrate of Embodiment 23, wherein the coating is applied at a coating weight from about 5 to about 20 g/m², as determined by ASTM F2217

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

1. A biodegradable aqueous mixture for coating substrates, the mixture comprising:
from 35 to 75 weight percent water and from 25 to 65 weight percent solids,
wherein the solids comprise from 40 to 99 weight percent of a first poly(hydroxyalkanoate) based on the total dry weight of the solids, and
wherein the first poly(hydroxyalkanoate) comprises at least 1 mole percent monomer repeat units of 3-hydroxypropionate.

2. The biodegradable aqueous mixture of claim 1, wherein the first poly(hydroxyalkanoate) comprises poly(3-hydroxypropionate).

3. The biodegradable aqueous mixture of claim 1, wherein the first poly(hydroxyalkanoate) is a copolymer or a terpolymer which comprises
a first repeat unit which is (3-hydroxypropionate),
a second repeat unit according to Formula I 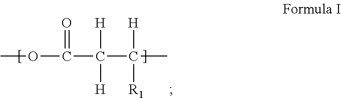
optionally, a third repeat unit according to Formula II, 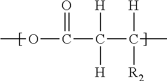
wherein R1 and R2 are each independently selected from the group consisting of linear or branched alkyl groups having from 1 to 22 carbon atoms.

4. The biodegradable aqueous mixture of claim 3, wherein the first poly(hydroxyalkanoate) comprises a copolymer and R₁ is methyl.

5. The biodegradable aqueous mixture of claim 4, wherein the poly(hydroxyalkanoate) copolymer comprises from 10 to 90 mole percent of the first repeat unit and from 90 to 10 mole percent of the second repeat unit.

6. The biodegradable aqueous mixture of claim 3, wherein the first poly(hydroxyalkanoate) comprises a terpolymer, R₁ is methyl, and R₂ is propyl.

7. The biodegradable aqueous mixture of claim 6, wherein the poly(hydroxyalkanoate) copolymer comprises from 15 to 75 mole percent of the first repeat unit, from 75 to 15 mole percent of the second repeat unit, and from 1 to 5 mole percent of the third repeat unit.

8. The biodegradable aqueous mixture of claim 1, wherein the first poly(hydroxyalkanoate) has a weight average molecular weight, as determined by ASTM D4001-20, of at least 50,000 Daltons.

9. The biodegradable aqueous mixture of claim 1, wherein the first poly(hydroxyalkanoate) has a weight average molecular weight, as determined by ASTM D4001-20, from 50,000 to 1,000,000 Daltons.

10. The biodegradable aqueous mixture of claim 1, wherein the solids further comprise a second poly(hydroxyalkanoate) which does not include monomer repeat units of 3-hydroxypropionate.

11. The biodegradable aqueous mixture of claim 1, wherein the solids further comprise at least one biodegradable polymer selected from the group consisting of polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, nano-cellulose, isosorbide esters, and mixtures thereof.

12. The biodegradable aqueous mixture of claim 1, wherein the mixture further comprises from 0.01 weight percent to 5.0 weight percent of at least one surfactant selected from the group consisting of polysorbates, aromatic polyethylene oxides, sorbitan derivatives, block copolymers of poly(ethylene oxide) and poly(propylene oxide), poly(glycol ethers), poly(vinyl alcohol), alkyl sulfates, alkyl phosphates, stearates, and mixtures thereof.

13. The biodegradable aqueous mixture of claim 1, wherein the mixture further comprises from 0.01 weight percent to 5.0 weight percent of at least one rheology modifier selected from the group consisting of polysaccharides, acrylate-based emulsion copolymers, viscosity depressants, and viscosity enhancers.

14. The biodegradable aqueous mixture of claim 1, wherein the mixture further comprises from 0.01 weight percent to 2.5 weight percent of at least one wetting and dispersing agent.

15. The biodegradable aqueous mixture of claim 1, wherein the mixture further comprises from 0.01 weight percent to 0.5 weight percent of at least one biocide or biostatic agent.

16. The biodegradable aqueous mixture of claim 1, wherein the mixture further comprises from 0.1 weight percent to 5.0 weight percent of at least one coalescing agent selected from the group consisting of bio-succinic acid based coalescing solvent, 2,2,4-trimethyl-1,3-pentanediol monoisobutyrate, dimethyl carbonate, methanol, ethanol, ketones, acetates, and or mixtures thereof.

17. The biodegradable aqueous mixture of claim 1, wherein the mixture further comprises from 1 weight percent to 35 weight percent of at least one filler selected from the group consisting of clays, calcium carbonate, talc, kaolinite, montmorillonite, bentonite, silica, chitin, titanium dioxide, nano clay, or mixtures thereof.

18. The biodegradable aqueous mixture of claim 1, wherein the mixture comprises poly(hydroxyalkanoate) particles having a Dv (90) particle size of no more than 20 microns, as determined using ISO 8130-13:201.

19. The biodegradable aqueous mixture of claim 1, wherein the mixture, when applied as a substrate coating, has an oxygen transmission rate of less than 50 cc/m²/24 h, as determined according to ASTM D3985.

20. The biodegradable aqueous mixture of claim 1, wherein the mixture, when applied as a substrate coating, has an oxygen transmission rate from 10 to 50 cc/m²/24 h, as determined according to ASTM D3985.

21. The biodegradable aqueous mixture of claim 1, wherein the mixture, when applied as a substrate coating, has a water vapor transmission rate of less than 50 g/m²/24 h g/m2/24 h, according to ASTM F1249.

22. The biodegradable aqueous mixture of claim 1, wherein the mixture, when applied as a substrate coating, has a water vapor transmission rate from 10 to 50 g/m²/24 h g/m2/24 h, according to ASTM F1249.

23. A coated substrate comprising:
a paperboard substrate having at least a first surface and a second surface; and
a coating layer over at least the first surface, wherein the coating is formed by applying the biodegradable aqueous mixture of claim 1.
